(19) United States
(12) Patent Application Publication
(10) Pub. No.: US 2009/0279901 A1
(43) Pub. Date: Nov. 12, 2009

(54) PASSIVE COMPONENT FOR ALL-OPTICAL REGENERATION OF HIGH LEVELS BY SATURABLE ABSORPTIONS CAVITY

(76) Inventor: Sébastien Sauvage, Paris (FR)

Correspondence Address: GREER, BURNS & CRAIN, 300 S WACKER DR, 25TH FLOOR, CHICAGO, IL, 60606, US

(21) Appl. No.: 12/374,945

(22) PCT Filed: Jul. 25, 2007
(86) PCT No.: PCT/FR07/01282

§ 371 Date: Jan. 23, 2009

(30) Foreign Application Priority Data
Jul. 26, 2006 (FR) 06 06845

(51) Int. Cl. H04B 10/06; G02F 1/35

(52) U.S. Cl. 398/208; 427/162

(57) ABSTRACT

An optical component for processing an optical signal, operating by reflection in a saturable absorption resonant cavity formed between a first so-called rear mirror and a second mirror situated on the side of the incident signal, the reflectivity of the second mirror being greater than or equal to the reflectivity of the rear mirror.

The invention relates to a passive saturable absorber component allowing the all-optical regeneration of an optical signal such as those used for digital data transmissions, as well as a method of regeneration and a device implementing this regeneration. The invention also relates to a method and a system for manufacturing such a component.

The context of the invention is the regeneration of signals and optical pulses, in particular for very high-rate long-distance optical telecommunications.

Numerous fields, such as data communication or telecommunications networks, use the transmission of digital signals by optical route over long distances, in general by optical fibres. During transmission or processing, these signals undergo a degradation, in particular in their shape or in their amplitude, which makes them more difficult to detect and to interpret.

Such degradations appear in particular over long distances such as in terrestrial transport networks of several hundred kilometres, and still more in submarine transoceanic or trans-pacific links of more than four or six thousand kilometres. Such degradations can also appear in the case of difficult transmission environments, for example poor-quality fibres or multiple intermediate processings generating disturbance or interference.

More particularly, the propagation of pulses in optical fibres leads to a deformation which is detrimental to the temporal profile of the pulses, and also to attenuation of their energy due to the propagation losses. The attenuation often requires the use of optical amplifiers arranged periodically along the transmission lines in order to restore energy to the pulses. This amplification stage also modifies the temporal shape of the pulses, in particular by adding intensity noise.

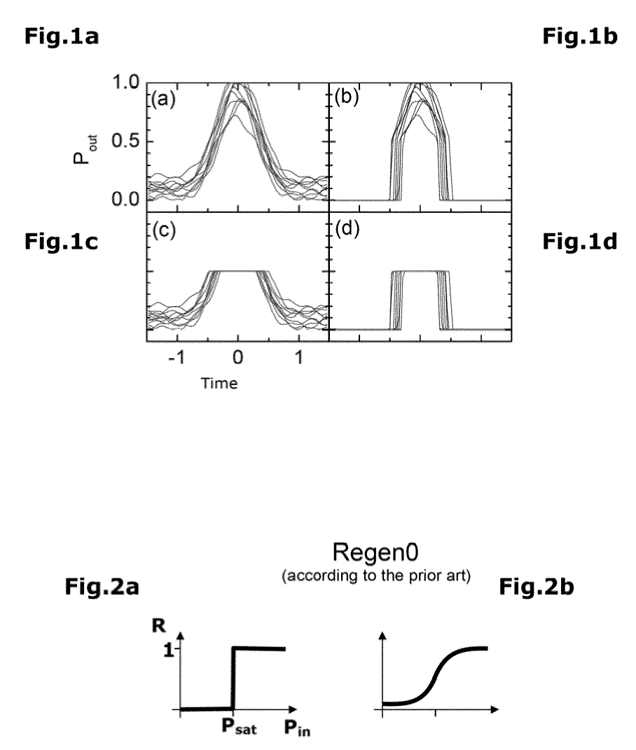

FIG. 1a shows a temporal profile typical of such degraded pulses. During reception of the pulses the intensity noise adversely affects the discrimination between the low levels (the “0”s) and the high levels (the “1”s) of the pulses, by introducing an error rate during their detection which can be a nuisance or incompatible with the efficient transmission of information.

Current telecommunication technologies use optical fibre transmission of digital monochromatic signals emitted by a laser or modulated at rates of the order of 10 Gb/s. In order to remedy the signal degradations, optoelectronic devices are interposed, carrying out signal regeneration operations, comprising reamplifying, reshaping and retiming, also called “3R” regeneration. These operations are carried out by electronic components, and require the conversion of the optical signals to electronic signals and vice versa.

Such equipment is at present complex, expensive, bulky, and also requires a power supply.

Furthermore, a novel technological stage in transmission is currently in the process of preparation with the development of equipment carrying out transmission at a rate of the order of 40 Gb/s. This technology also envisages the use of wavelength division multiplexing (WDM) allowing an overall rate of the order of 1 terabit per second, for example 32 channels of 40 Gb/s each. This novel technology further enhances the benefit of being able to improve the signal regeneration process.

For this purpose, regeneration methods of all-optical type have been proposed, i.e. without requiring optical-electronic conversion, and of passive type, i.e. using as their only source of energy the energy of the pulses themselves without any external energy supply.

The patent of invention FR2 835 065 proposes for example a component allowing the regeneration of the low levels of the pulses, which will here be referred to as Regen0. This Regen0 regeneration function is obtained by means of a component operating in reflection and using a non-linear optical material with saturable absorption.

The reflectivity R of the component describes the fraction of input power Pᵢₙ which is reflected by the component. The non-linearity of the reflectivity is expressed by the fact that R depends on Pᵢₙ. At the output the pulse power is then Pₒᵤₜ=R(Pᵢₙ)·Pᵢₙ. The input power of the pulses is assumed to be of the order of the saturation power Pₛₐₜ of the component, which is the typical power at which the optical non-linearity is produced.

The effect in principle of such a Regen0 regeneration on the temporal profile of the pulses is diagrammatically represented in FIG. 1b, without taking certain other constraints into account. Such a reshaping effect is obtained by means of a reflectivity which exhibits a dependence with the input power Pᵢₙ, as represented, in principle, in FIG. 2a. Well below the saturation power Pₛₐₜ, the output power is zero: Pₒᵤₜ=0 and the noise is eliminated. Well above this saturation power, the reflected power is unchanged: Pₒᵤₜ=Pᵢₙ. Ideally the Regen0 function therefore makes it possible to maximize the contrast of the pulses and to ensure error-free detection of the pulses, for example by positioning the threshold for detection of the pulses at Pₛₐₜ.

In practice such a reflectivity R(Pᵢₙ) can be obtained according to the known art by means of a Fabry-Perot cavity based on semi-conductors containing saturable absorber layers. These cavities are constituted by a rear mirror of reflectivity R_{b} and by a front mirror of lower reflectivity R_{f}. The function of regeneration of the low levels Regen0 is obtained by arranging the structure of the component in order as far as possible to meet the following impedance adaptation condition:

R_{f}=exp(−2α₀L)R_{b} (1)

where α₀L is the total absorbance of the intra-cavity layers.

The corresponding reflectivity is diagrammatically represented in FIG. 2b. The low reflectivity at low powers ensures the partial elimination of the low pulse levels whereas the higher reflectivity at the high powers promotes the reflection of the high pulse levels. Finally, the increase in the pulse contrast and better discrimination between these high and low levels is ideally expected, leading to a reduction in the detection error rates.

However these techniques have certain limits which hinder in particular the simplification and improvement of the existing technologies (10 Gb/s) as well as the development and industrialization of the novel technologies (40 Gb/s).

Due to the fact that they regenerate only the low-level pulse shape, i.e. the shape of the “0”s, these techniques do not improve and even increase the noise present in the high levels of these pulses, which remains a cause of disturbance for detection of the signal.

Furthermore, this regeneration of the “0”s amplifies the relative noise δPₒᵤₜ/Pₒᵤₜ on the “1”s, because of the always positive gradient of the reflectivity R(Pᵢₙ), as can be seen in the bottom part of FIG. 6. This leads to a reduction in the deviation making it possible to distinguish the low levels from the high levels, i.e. to a closing of the “eye diagram”, in particular during the concatenation of such regenerators along transmission lines. As a result this technique does not make it possible to concatenate many regenerators without the risk of increasing the binary error rate, which is the opposite of the sought effect.

A purpose of the invention is to remedy the drawbacks of the known art, for example by reducing the complexity, fragility, sensitivity, cost, or space requirement of the regenerators necessary to maintain a transmission of satisfactory quality.

More particularly, the invention seeks to obtain an all-optical regeneration of the shape of the “1”s of the signal transmitted, if possible in a passive manner.

The invention also seeks to obtain a passive all-optical regeneration of the shape both of the “1”s and of the “0”s of the transmitted signal, if possible combined in the same component.

An objective is also to obtain all or some of these advantages in a configuration or space requirement which can be used in WDM transmission technologies using wavelength multiplexing.

One of the purposes of the invention is to obtain all or some of these advantages combined with rapid response times, in particular compatible with the technologies with a rate of 40 Gb/s.

Another purpose is also to obtain all or some of these advantages in a reliable and robust configuration making it possible to implement passive all-optical regeneration techniques even without achieving the response times necessary for future technologies. It may for example be a matter of improving the components used in the current technologies of 10 Gb/s or less. It may also be a matter of satisfying the needs of those involved in fundamental or industrial research, for example in order to advance research into new components or to study the capacities and problems of passive all-optical regeneration within larger systems and over time.

The invention proposes a component, preferably monolithic, ensuring, by its non-linear reflectivity R(Pᵢₙ), a function of passive regeneration of the high levels of the pulses of a signal.

For this purpose, the invention proposes the use of a saturable absorber cavity in a completely counter-intuitive configuration, which consists of the use of a rear mirror which is less reflective than that which is placed in front of it.

This cavity is used in reflection of the optical signal, i.e. the incident signal is injected into the cavity and leaves it again, after resonance, in the general direction from where it has come. Within this cavity, the first and the last reflection of the signal takes place in the direction of a reflection on the rear mirror.

An optical component is then obtained for processing an optical signal which operates by reflection of this signal in a saturable absorber resonant cavity formed between a first so-called rear mirror and a second mirror situated at the side of the incident optical signal, the reflectivity of the second mirror being greater than or equal to the reflectivity of the rear mirror.

In a first embodiment, such a component is used in order to carry out a regeneration of the high levels of the signal. This embodiment then ensures a so-called “Regen1” function by a passive all-optical solution. In this configuration, the second mirror can be called the “front mirror”.

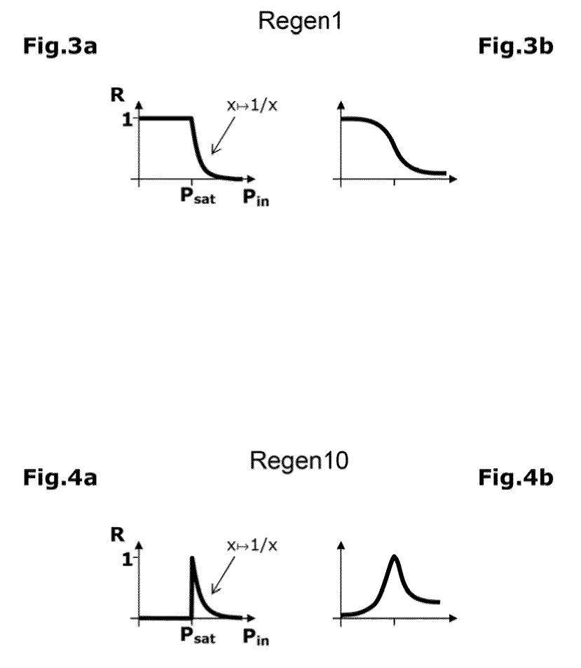

Such a Regen1 component has a reflectivity as represented, in principle, in FIG. 3a, and obtained in practice as diagrammatically represented in FIG. 3b. This function leaves the low powers unchanged. On the other hand, the dependence of the reflectivity on the reciprocal of the input power, i.e. 1/Pᵢₙ, beyond the saturation power ensures the suppression of the noise at the high pulse levels. The output power is then constant and equal to the saturation power: Pₒᵤₜ=Pₛₐₜ=constant. FIG. 1c shows, in principle, the effect obtained on noisy pulses such as those of FIG. 1a.

Such a component of Regen1 type can then be coupled with a component performing the Regen0 function, for example a component of the type mentioned previously. Preferably, the invention proposes passing the signal first through the component Regen0 and then through the component Regen1.

In a second embodiment, the invention proposes a component, preferably monolithic, ensuring, by its non-linear reflectivity R(Pᵢₙ), a passive function of regeneration of the high levels and of the low levels of the pulses.

For this purpose, the invention proposes adding another saturable absorber cavity above the first, i.e. on the same side as the incident optical signal with respect to the second mirror. Such a component thus comprises a second saturable absorption resonant cavity formed between the second mirror and a third mirror situated on the same side as the reflection of the optical signal with respect to the second mirror. In this configuration, the third mirror can be called the “front mirror” and the second mirror can then be called the “median mirror”.

In this second embodiment, the component provides a passive all-optical solution to the simultaneous regeneration of the “1”s and the “0”s, i.e. an integrated function which is called “Regen10”.

Such a component Regen10 has a sought reflectivity as represented, in principle, in FIG. 4a, and the results obtained in practice are diagrammatically represented in FIG. 4b. The noise on the low levels, the power of which is less than the saturation power Pₛₐₜ, is eliminated as the reflectivity is zero. The noise on the high levels, the power of which is greater than the saturation power Pₛₐₜ, is also eliminated by means of the dependence of the reflectivity on 1/Pᵢₙ. The effect obtained on noisy and accumulated pulses is represented, in principle, in FIG. 1d.

The invention also proposes a method for the regeneration of an optical signal by the use of such components, as well as a device implementing this method and a telecommunication system comprising such a device. The present invention also relates to a method and a system for manufacturing such components.

For the regeneration of the high levels of the pulses (“Regen1” function), the invention provides in particular the same types of advantages as the techniques currently known for obtaining the “Regen0” function as mentioned above. These advantages are expressed in particular in terms of spectral band admissible for operating with wavelength division multiplexed (WDM) systems, of reduced saturation power compared to the non-cavity saturable absorbers, with a thermally favourable structure in a configuration with reflection, cost, compactness and development potential for future very high-rate applications (for example 160 Gbit/s).

The invention makes it possible in particular to passively regenerate the “1”s, i.e. to reduce the noise on these high levels, without providing any external energy other than that of the pulses themselves. Furthermore, this regeneration takes place in multi-channel mode and makes it possible to process several channels simultaneously with the same component.

The invention moreover makes it possible to regenerate the “0”s and the “1”s simultaneously and passively by reducing the noise on both these levels by means of a monolithic component, requiring little space and combining several functions for less cost and complexity than that of the production and coupling of two different components.

The fact of simultaneously regenerating the high and low levels moreover makes it possible to avoid or limit certain harmful side effects of the known “Regen0” technology, such as the closing of the abovementioned “eye diagram”.

Thus, by making it possible to regenerate the high levels, the invention makes it possible to overcome a technological obstacle by allowing the production of devices which completely regenerates the shape of the signals. These devices can operate in a passive and all-optical manner, which makes it possible to design compact apparatuses which can be arranged in isolated locations with no energy supply.

Other features and advantages of the invention will become apparent from the detailed description of embodiments which are in no way limitative, and from the attached drawings, where:

FIG. 1a to FIG. 1d show the power curve as a function of time for a group of pulses in the case:

FIG. 1a: of noisy input pulses with limited contrast,

FIG. 1b: of the same pulses, in a simplified manner, after regeneration of the shape of the low levels,

FIG. 1c: of the same pulses, in a simplified manner, after regeneration of the shape of the high levels, and

FIG. 1d: of the same pulses, in a simplified manner, after regeneration of the shape of the high and low levels;

FIG. 2a and FIG. 2b diagrammatically represent the reflectivity as a function of the power received, for a component according to the prior art (Regen0):

FIG. 2a: in a form representing its effect in principle,

FIG. 2b: in a form closer to practice;

FIG. 3a and FIG. 3b diagrammatically represent the reflectivity as a function of the power received, for a component of Regen1 type according to the first embodiment of the invention:

FIG. 3a: in a form representing its effect in principle,

FIG. 3b: in a form closer to practice;

FIG. 4a and FIG. 4b diagrammatically represent the reflectivity as a function of the power received, for a component of Regen10 type according to the second embodiment of the invention:

FIG. 4a: in a form representing its effect in principle,

FIG. 4b: in a form closer to practice;

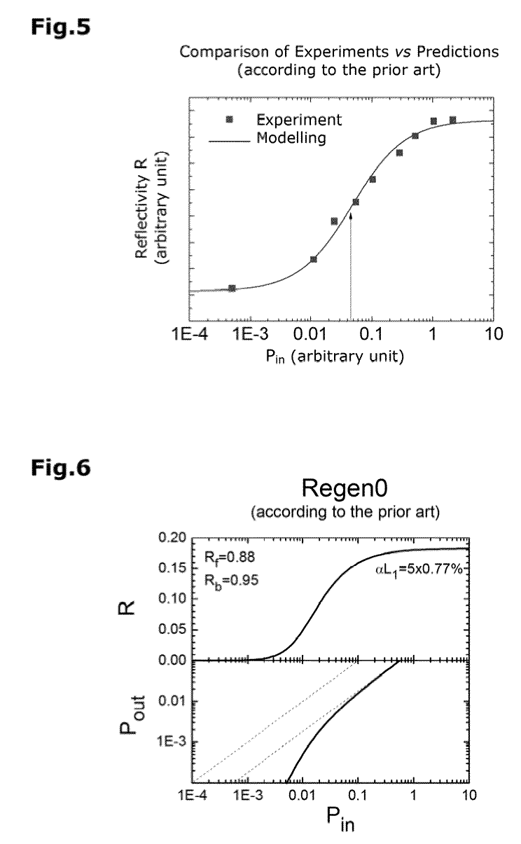

FIG. 5 shows, for the reflectivity as a function of the input power, a comparison between an experimental measurement carried out on a component of Regen0 type according to the known art and the prediction of the model used to design the invention;

FIG. 6 shows, as a function of the input power, the calculated reflectivity and the output power of a saturable absorber optical cavity in a configuration close to a Regen0 type;

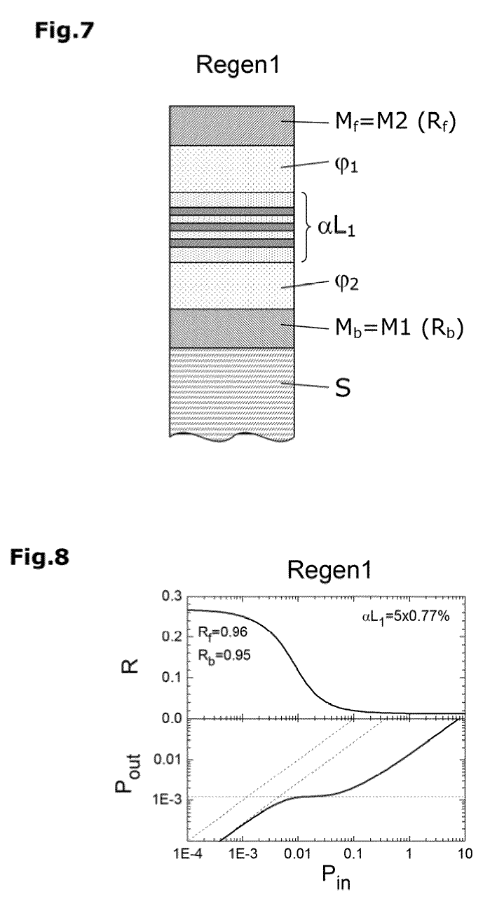

FIG. 7 diagrammatically represents a saturable absorber optical cavity for a component of Regen1 type according to the first embodiment of the invention;

FIG. 8 shows, as a function of the input power, the calculated reflectivity and output power of a saturable absorber optical cavity for a component of Regen1 type according to the first embodiment of the invention;

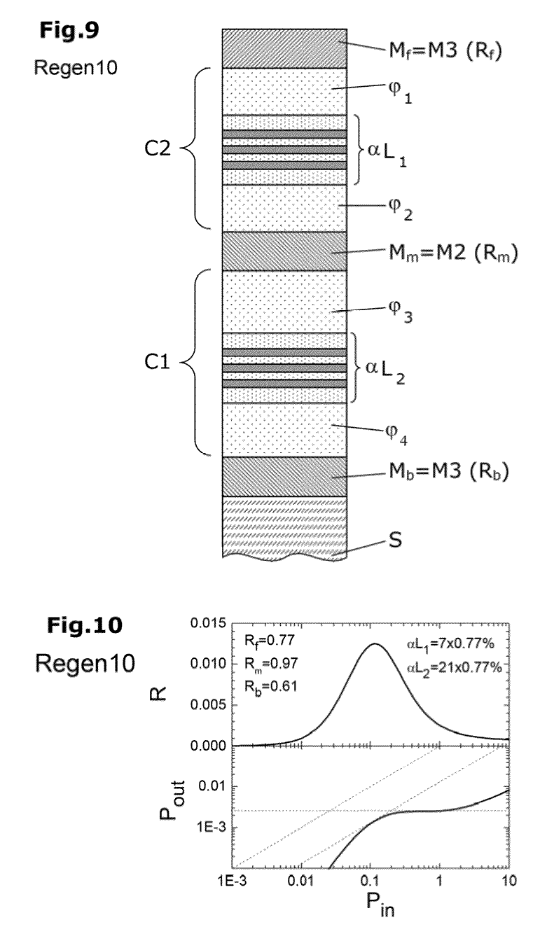

FIG. 9 diagrammatically represents a saturable absorber optical cavity for a component of Regen10 type according to the second embodiment of the invention;

FIG. 10 shows, as a function of the input power, the calculated reflectivity and output power of a saturable absorber optical cavity for a component of Regen10 type according to the second embodiment of the invention;

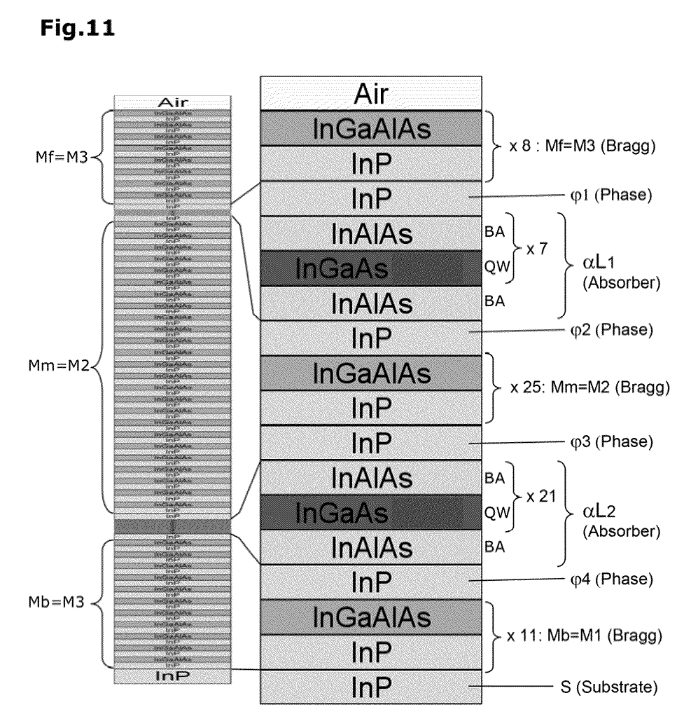

FIG. 11 shows a realistic embodiment example of the structure of a saturable absorber optical cavity with Bragg mirrors and quantum wells, for a component of Regen10 type according to the second embodiment of the invention;

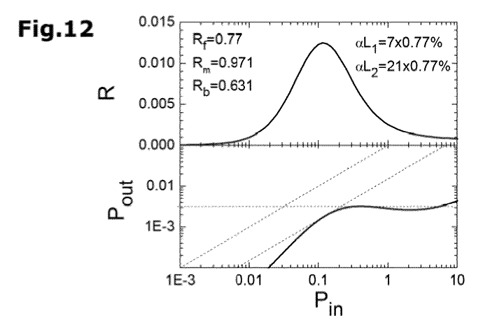

FIG. 12 shows, as a function of the input power, the calculated reflectivity and output power for the realistic structure example of FIG. 11;

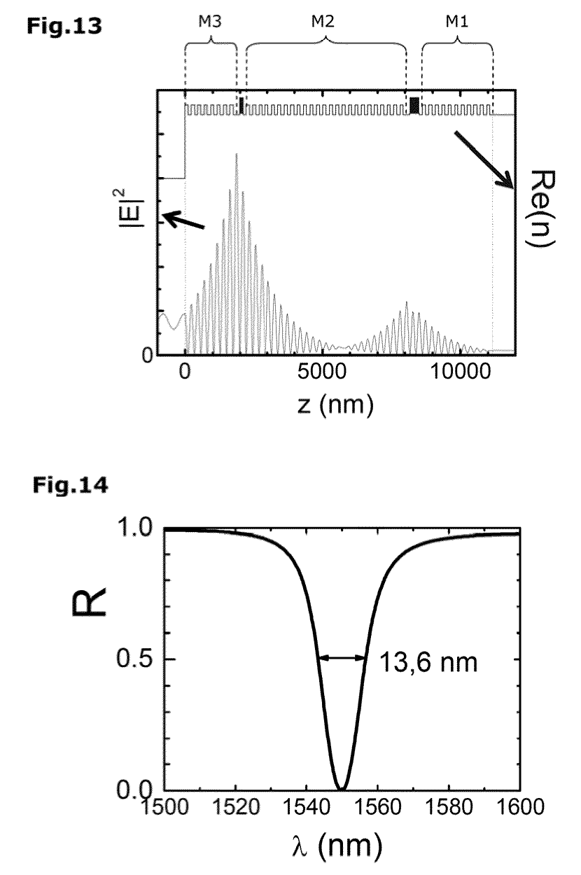

FIG. 13 shows the distribution of the amplitude of the electric field in the structure example of FIG. 11, at the resonance of FIG. 14;

FIG. 14 shows the calculated spectral dependence of the reflectivity of the realistic structure example of FIG. 11.

The present invention was quantified and tested by digital simulation, through mathematical modelling of the optical behaviour of the materials and their combination.

Measurements making it possible to quantitatively report the reflectivity measurements were carried out on material samples of components carrying out the regeneration of the low level of the pulses (“Regen0” function). As illustrated in FIG. 5, this mathematical model was then adjusted and verified by comparing these real measurements with the values that it predicts for these same material samples. These material samples have the reflectivity characteristics R_{f}=0.88 for the front mirror, R_{b}=0.95 (R_{f}≦R_{b}) for the rear mirror and a saturable absorption αL₁=3.85% equivalent to that of 5InGaAs quantum wells epitaxied on InP.

FIG. 6 shows these same predicted values of the reflectivity R(Pᵢₙ) and output power Pₒᵤₜ as a function of the power of the input pulses Pᵢₙ. The realistic model used to make these predictions is based on the resolution of Maxwell equations for stacks of layers of materials of optical index having a complex part. The law of realistic absorption saturation used is

$$α L ( P ) = \frac{α {L}_{0}}{1 + P / {P}_{sat}}$$

where P represents the power (linked to the intensity) of the electromagnetic wave in the cavity at the level of the quantum wells.

The curve Pₒᵤₜ is compared with the dotted straight lines corresponding to a linear dependence Pₒᵤₜ=αPᵢₙ where α is a constant. The constant gradient of the dotted straight lines on a logarithmic scale corresponds to the boundary case where no relative noise is added to Pₒᵤₜ, with respect to Pᵢₙ. When the gradient of Pₒᵤₜ on a logarithmic scale is smaller than that of the dotted straight lines, the relative noise on Pₒᵤₜ is lower that on Pᵢₙ and corresponds to the effect produced by the invention, of optical limiter type.

When the gradient of Pₒᵤₜ on a logarithmic scale is greater than that of the dotted straight lines, as is the case in FIG. 6 describing the known art, the relative noise on Pₒᵤₜ is increased at each passage through the regenerator, which is detrimental. This figure shows that the Regen0 components according to the known art not only do not regenerate the high levels of the pulses, but considerably degrade the noise on the “1”s whatever the input power used.

In the first embodiment of the invention, FIG. 7 diagrammatically illustrates the structure of a component of Regen1 type. This component comprises a so-called Fabry-Perot cavity formed between a first mirror M1 (or rear mirror M_{b}) of reflectivity R_{b} and a second mirror M2 (in this case called the front mirror M_{f}) of reflectivity R_{f}. These two mirrors are set in a saturable absorber material with a total absorption equivalent to αL₁, i.e. corresponding to an absorption index “α” over a length “L₁”. This saturable absorber is separated from each of the two mirrors by two phase layers φ₁ and φ₂. The cavity rests on a substrate S removing the heat produced by the absorption of the pulses. With respect to the known art for the all-optical regeneration of the pulses, this cavity is designed with the original and counter-intuitive characteristic: R_{f}≧R_{b} i.e. a reflectivity of the front mirror (M_{f}) greater than the reflectivity of the rear mirror (M_{b}).

Thus, it is very clear that the relationship between R_{b} and R_{f} no longer corresponds to the impedance adaptation relationship (relationship (1) mentioned above) which is recognized as necessary in the prior art, and on the contrary describes a “returned” or “reversed” cavity. This specific characteristic allows the all-optical regeneration of the high levels of the pulses.

The production of the component Regen1 uses known semi-conductor epitaxy techniques, and different known technological methods applied to these materials. The saturable absorber can be constituted, non-limitatively and given by way of example, by one or more solid GaInAs or GaAlAs layers, one or more InGaAs or GaAlAs quantum wells, one or more planes of InGaAs quantum dots or boxes inserted into InP or GaAs barriers and absorbing at the operating wavelengths of the component, i.e. about 1.3 and 1.55 μm for the components used for current optical telecommunications.

In the case of the quantum wells, in order to minimize the polarization dependence of the normal-incidence reflectivity, a dependence due to the absorption dichroism of the quantum wells and the crystal anisotropy at the interfaces, according to the invention semi-conductor quantum wells with common atoms, and preferably with common anions, in the barriers will be chosen, for example: InGaAs quantum wells between InAlAs barriers. The polarization dependence of the absorption is given in the document: Investigations of giant “forbidden” optical anisotropy in GaInAs—InP quantum well structures, O. Krebs, W. Seidel, J. P. Andre, D. Bertho, C. Jouanin, P. Voisin, Semicond. Sci. Technol. 12 (1997) 938-942.

The absorption is saturable i.e. it tends towards zero when the power (or the intensity) of the wave which passes through the absorber material tends to infinity. In practice the experimental saturable absorption exhibits a dependence which can be described around the saturation power by the formula: αL(Pᵢₙ)=αL₀/(1+Pᵢₙ/Pₛₐₜ) where αL₀ is the absorption of the material in the absence of illumination. From the point of view of time, the saturable absorption can be made more rapid, with a picosecond or sub-picosecond response time, by using a low-temperature epitaxial growth, or using the incorporation of impurities or also the irradiation of the layers with heavy or light ions.

Apart from the mirrors and saturable absorber layers, the other layers are, as far as possible, transparent at the working wavelengths.

The mirrors of the cavity have a reflectivity less than 1, and are considered without losses. The rear mirror M_{b} is preferably metallic, and the other mirrors are of a type which allows the wave energy which is not reflected to pass through. In practice the existence of residual losses in the mirrors does not modify the concept of the invention. By way of example and non-limitatively, the mirrors can be produced in the form of “Bragg mirrors” according to known techniques, either by epitaxy of semi-conductor layers, or obtained by deposition of dielectric layers. The stacking of the different layers and the transfer of the structure composed of the cavity and saturable absorbers, onto a substrate S are carried out according to known techniques.

FIG. 8 describes the reflectivity R(Pᵢₙ) and the dependence of the output power Pₒᵤₜ for the component Regen1 according to the first embodiment of the invention as represented in FIG. 7, with the relationship R_{f}≧R_{b}. The impedance adaptation relationship according to the known art is therefore not produced. The case considered is an example which is in no way limitative, and has reflectivity characteristics equivalent to R_{f}=0.96, R_{b}=0.95 and αL₁=3.85%. It will be noted that reflectivities higher than 0.95-0.96 can be used perfectly well and lead to a useful reduction in the losses of the component according to the invention. The case considered therefore has a general value.

The cancellation of the gradient of the curve Pₒᵤₜ makes it possible to ensure the regeneration of the high levels of the pulses by eliminating the noise on these levels. The gradient of the curve Pₒᵤₜ which is smaller on a logarithmic scale than the dotted straight lines of gradient 1, at all powers, shows that the invention also adds no noise to the low levels of the pulses. Thus the reflectivity of the first component according to the invention makes it possible to ensure a regeneration of Regen1 type.

It should be noted that the sought effect can be obtained with reflectivities Rf and Rb having values which are not very different from each other (0.96 and 0.95), whereas the impedance adaptation relationship (1) influencing the Regen0 operation according to the prior art provides pairs of values far from this equality, for example 0.88 and 0.95. The characteristics of the invention defining by a reflectivity R_{f} of the front mirror greater than that R_{b} of the rear mirror does not therefore exclude the case where these two values are substantially equal or even slightly reversed.

Advantageously, a Regen1 component according to the invention can be concatenated with a Regen0 component according to the known art, in order simply and efficiently to produce a Regen10 regeneration function for regeneration of the high levels and the low levels.

Preferably, the Regen1 component is placed after the Regen0 component in order that the composition of the regeneration functions produces the Regen10 function.

According to the second embodiment of the invention, FIG. 9 diagrammatically illustrates the structure of a component of Regen10 type. This component is formed by two coupled Fabry-Perot cavities sharing a so-called central or median mirror Mₘ of reflectivity Rₘ. A first C1 of these cavities is formed between a first mirror M1 (referred to as the rear mirror M_{b}) and a second mirror M2, in this case constituted by this median mirror Mₘ. The second C2 of these cavities is formed between this same median mirror Mₘ and a third mirror M3 (in this case referred to as the front mirror M_{f}). Each of these cavities C2 and C1 is set in a saturable absorber material, αL₁ and αL₂ respectively, each of these absorber materials being separated from the adjacent mirrors by two phase layers φ₁, φ₂ for αL₁ and φ₃, φ₄ for αL₂ respectively. The phase shifts φ₁+φ₂ and φ₃+φ₄ introduced by the phase layers are chosen so that the working wavelength corresponds spectrally to a reflectivity resonance. The structure rests on a substrate S which is transparent at the operating wavelengths of the invention which makes it possible to remove part of the electromagnetic energy away from the structure.

The three mirrors M_{f}, Mₘ and M_{b} are partially transparent and have reflectivities R_{f}, Rₘ and R_{b} respectively, ideally transmitting 1−R_{f}, 1−Rₘ, and 1−R_{b}. They may be produced from dielectric layers or Bragg mirrors produced for example by epitaxial growth of semi-conductors. The reflectivities satisfy the following two relationships: Rₘ≧R_{f} and Rₘ≧R_{b} in order to be able to obtain the all-optical and simultaneous regeneration of the high levels and low levels of the pulses. The reflectivity of such a structure is written:

$$R = \frac{{( \begin{matrix}exp ( - α {L}_{1} ) ( exp ( - α {L}_{2} ) \sqrt{{R}_{b}} - \sqrt{{R}_{m}} ) + \\ \sqrt{{R}_{f}} ( 1 - exp ( - α {L}_{2} ) \sqrt{{R}_{b} {R}_{m}} )\end{matrix} )}^{2}}{{( \begin{matrix}\sqrt{{R}_{b} {R}_{m}} exp ( - α {L}_{2} ) + exp ( - α {L}_{1} ) \sqrt{{R}_{f}} \\ ( \sqrt{{R}_{m}} - exp ( - α {L}_{2} ) \sqrt{{R}_{b}} ) - 1\end{matrix} )}^{2}} \qquad ( 2 )$$

The design of a component according to the invention ensuring the function Regen10 therefore involves determining the three reflectivities R_{f}, Rₘ, R_{b} and the two saturable absorptions αL₁ and αL₂.

In a particularly useful example, for the Regen10 component of FIG. 9, expressing zero reflectivity at infinitely low input power, the choice of these parameters can be determined by satisfying a so-called impedance adaptation relationship which is written as follows:

$${R}_{f} = \frac{exp ( - 2 α {L}_{1} ) {( \sqrt{{R}_{m}} - exp ( - α {L}_{2} ) \sqrt{{R}_{b}} )}^{2}}{{( exp ( - α {L}_{2} ) \sqrt{{R}_{b}} \sqrt{{R}_{m}} - 1 )}^{2}} \qquad ( 3 )$$

In practice it is not necessarily sought to precisely satisfy this relationship, preferring for example to adjust the dependence of the reflectivity with the incident power in order to ensure the best Regen10 regeneration function.

FIG. 10 describes the reflectivity and the output power for the component described previously and predicted from the above analytical expression (2), for the following values:

| | |
|---|---|
| R_{f} = 0.77 | αL₁ = 7 × 0.77% |
| Rₘ = 0.97 | αL₂ = 21 × 0.77% |
| R_{b} = 0.61 | |

The shape of the reflectivity curve satisfies the shape sought for a Regen10 function as represented in FIG. 4b. Quantitatively the gradient Pₒᵤₜ greater than 1 (on a logarithmic scale) at the low input powers increases the contrast of the pulse whereas the plateau of Pₒᵤₜ eliminates the noise on the high levels of the pulses. The plateau corresponds to a reflectivity R(Pᵢₙ) which is inversely proportional to Pᵢₙ: R(Pᵢₙ)=α/Pᵢₙ, with a=a constant, which has the sought optical limiter type effect.

FIG. 11 shows a structure constituting an embodiment example of a component of Regen10 type according to the second embodiment of the invention, in a diagrammatic representation on the left and a symbolic representation on the right. This example must not be seen as limitative and makes it possible in particular to show that it is possible to design, in concrete terms, a component of Regen10 type having a configuration compatible with the technologies for production and implementation of such categories of components. The component is formed from three Bragg mirrors M1, M2 and M3 based on epitaxiated semi-conductors, for example by organometallic chemical vapour phase deposition, alternating submicrometric layers of quaternary InGaAlAs and binary InP. These layers number 11 pairs for the first mirror M1 (or M_{b}), 25 pairs for the second mirror M2 (or Mₘ) and 8 pairs for the third mirror M3 (or M_{f}). These three mirrors are set in a series of quantum wells QW, in this case made of InGaAs, alternating with barriers BA, in this case made of InAIAs, epitaxiated according to the same method and the thicknesses of which are chosen in order to provide an absorption at the telecommunications wavelength of 1.55 μm. The first series αL₁ contains 7 quantum wells and 8 barrier layers BA. The second series αL₂ contains 21 quantum wells and 22 barrier layers BA. The mirrors and the series of quantum wells are separated by phase layers φ₁, φ₂, φ₃ and φ₄ made of InP. The structure is itself epitaxiated on a substrate S which is transparent at a wavelength of 1.55 μm.

The different layers have the following thicknesses:

| Layer | Material | Thickness (nm) |
|---|---|---|
| M3 | InGaAlAs | 110.5 |
| M3 | InP | 122.7 |
| φ₁ | InP | 118 |
| BA | InAlAs | 7 |
| QW | InGaAs | 9 |
| BA | InAlAs | 7 |
| φ₂ | InP | 118 |
| M2 | InGaAlAs | 110.5 |
| M2 | InP | 122.7 |
| φ₃ | InP | 116 |
| BA | InAlAs | 7 |
| QW | InGaAs | 9 |
| BA | InAlAs | 7 |
| φ₄ | InP | 116 |
| M1 | InGaAlAs | 110.5 |
| M1 | InP | 122.7 |

The assembly represents a thickness of approximately 11 μm, represented substantially to scale along the abscissa “z” of FIG. 13.

This embodiment example then has the following reflectivity and absorption values:

| | |
|---|---|
| R_{f} = 0.77 | αL₁ = 7 × 0.77% |
| Rₘ = 0.971 | αL₂ = 21 × 0.77% |
| R_{b} = 0.631 | |

FIG. 12 shows the reflectivity and dependence of the output power as a function of the input power, obtained for this same embodiment example. The stacking of the different layers leads to a regeneration function very close to that deduced from the analytical formula (2) and shows that the operation of the structure of this embodiment example does have the Regen10 characteristics allowing the regeneration of the high and low levels.

FIG. 13 shows the distribution of the squared module of the electric field E at the resonance wavelength (1550 nm), in its distribution over the thickness “z” of the structure of this same embodiment example. The electric field E results from the interference between the contra-propagative waves which are established in the structure due to the multiple reflections on the interfaces between the different layers of epitaxiated semi-conductors. The optical index profile over the thickness of the structure is represented on the ordinate on the right for reference, and appears at the top of the figure. The electric field is maximum at the level of the two series of quantum wells, thus making it possible to minimize the saturation power of their absorption.

FIG. 14 illustrates the spectral response of the Regen10 component according to the invention in its second embodiment, for the previous embodiment example and in the case of low intensities. It can be seen that the reflectivity R is cancelled at a wavelength of 1.55 μm, as the number of layers in the Bragg mirrors and in the series of quantum wells has been chosen in order to ensure the low power impedance adaptation for this wavelength value. This impedance adaptation is obtained by determining reflectivity values in accordance with the relationship (3) proposed by the invention for the “Regen10” component, a relation which is different from the relationship (1) used in the prior art. The curve obtained for the low intensity regime spectrum indicates that the impedance adaptation of the type providing zero reflectivity at low intensity can be obtained for this component.

When the wavelength deviates from 1.55 μm, a discrepancy is introduced into the cavity due to the mismatch of the wavelength to the chosen thicknesses. The mid-height spectral width predicted for the resonance is 13.6 nm, and indicates the typical wavelength range over which the component can be used in a low-intensity regime.

The components according to the invention can be used in order to produce numerous types of light-signal processing devices, in particular of passive all-optical type, and for example:
a telecommunications light-signal processing device, comprising a component according to the invention for passively regenerating the high levels of said signal;
a telecommunications light-signal-processing device comprising at least one first component according to the invention for passively regenerating the high levels of a telecommunications light signal, preceded by at least one second component for passively regenerating the low levels of said signal, said second component comprising at least one saturable absorber cavity formed by an absorber of absorption α₀L inserted between a rear mirror of reflectivity R_{b} and a front mirror of reflectivity R_{f}, said reflectivities substantially conforming with the impedance adaptation relationship R_{f}=exp(−2α₀L)R_{b};
a telecommunications light-signal processing device, comprising at least one monolithic component according to the invention for passively regenerating the high and low levels of said signal.

Furthermore, the component according to the invention can be produced in order to process a spectral range of a certain width, typically 5 to 20 nm in width. Such devices can thus be produced in a multi-channel version for a limited cost, complexity and space requirement.

Such devices can be used in order to establish the telecommunications systems of the next generations, for example with a channel rate of 40 Gb/s, and possibly of a subsequent generation at a rate of the order of 160 Gb/s.

Components or devices according to the invention can also be integrated into existing systems or systems with similar performances, for example for the purpose of simplifying their operation, or making them more compact, more reliable, more efficient, more economical, or improving their compatibility with future systems.

Such components or devices can also be very useful for testing, for example in a research laboratory or in industrial validation, the capacities and limits of the systems under development, or of other components which can be used in such systems.

Of course, the invention is not limited to the examples which have just been described and numerous adjustments can be made to these examples without exceeding the scope of the invention.

1. An optical component for processing an optical signal, operating by reflection in a saturable absorption resonant cavity formed between a first so-called rear mirror and a second mirror situated on the side of the incident signal, the reflectivity of the second mirror being greater than or equal to the reflectivity of the rear mirror.

2. An optical component for processing an optical signal, operating by reflection in a saturable absorption resonant cavity formed on a substrate between a first so-called rear mirror, of metallic type and situated on the side of said substrate, and a second mirror the reflectivity of the second mirror being greater than or equal to the reflectivity of the rear mirror.

3. The component according to claim 1, characterized in that the reflectivity of the second mirror is strictly greater than the reflectivity of the rear mirror.

4. The component according to claim 1, characterized in that it also comprises a second saturable absorption resonant cavity formed between the second mirror and a third mirror situated on the side of the incident signal with respect to said second mirror.

5. The component according to claim 4, characterized in that the reflectivity of the second mirror is greater than or equal to the reflectivity of the third mirror.

6. The component according to claim 1, characterized in that a saturable absorber comprises at least one alternation of barrier layers and layers producing quantum wells.

7. The component according to claim 6, characterized in that at least one quantum well layer is produced from a semiconductors the chemical composition of which has at least one atom or anion common with at least one barrier layer which is contiguous with it.

8. The component according to claim 1, characterized in that a saturable absorber comprises at least one layer producing a plane of quantum dots or boxes.

9. The component according to claim 1, characterized in that at least one of the mirrors is produced in order to allow most of the electromagnetic energy which it does not reflect to pass through.

10. The component according to claim 1, characterized in that the rear mirror is produced in order to allow most of the electromagnetic energy which it does not reflect to pass through, and rests on a substrate allowing most of the electromagnetic energy received by said substrate at the operating wavelengths of the component to pass through.

11. The component according to claim 1, characterized in that at least one of the mirrors is produced by epitaxy of semi-conducting layers forming a Bragg mirror.

12. The component according to claim 1, characterized in that at least one of the mirrors is produced by depositing dielectric layers forming a Bragg mirror.

13. A device for processing a telecommunications light signal, comprising at least one component according to claim 1.

14. A device for processing a multi-channel telecommunications light signal, comprising at least one component according to claim 1.

15. A device for processing a telecommunications light signal comprising at least a first component according to claim 1, preceded by at least one second component, said second component comprising at least one saturable absorber cavity formed by an absorber of absorbance α₀L inserted between a rear mirror of reflectivity R_{b} and a front mirror of reflectivity R_{f}, said reflectivities substantially conforming with the impedance adaptation relationship R_{f}=exp(−2α₀L)R_{b}.

16. A device for processing a telecommunications light signal comprising at least one monolithic component according to claim 4.

17. A method for producing an optical component for processing an optical signal according to claim 1, this method comprising a stacking of layers forming a saturable absorption resonant cavity between a first so-called rear mirror and a second mirror situated on the side of the incident signal, the reflectivity of the second mirror being greater than or equal to the reflectivity of the rear mirror

18. The method according to claim 17, characterized in that at least one layer is formed by low-temperature epitaxial growth.

19. The method according to claim 17, characterized in that it comprises incorporation of impurities into at least one layer.

20. The method according to claim 17, characterized in that it comprises ionic irradiation of at least one layer.

21. A method for processing a telecommunication signal, using at least one component or a device according to claim 1 for carrying out a regeneration of the high levels of said signal.

22. A manufacturing system implementing the method according to claim 17.

23. A telecommunication system comprising at least one component or device according to claim 1.
